(19) United States
(12) Patent Application Publication
(10) Pub. No.: US 2012/0272254 A1
(43) Pub. Date: Oct. 25, 2012

(54) OPTICAL PICKUP DEVICE AND OPTICAL DISC APPARATUS

(76) Inventor: Kazuyoshi Yamazaki, Yamato (JP)

(21) Appl. No.: 13/451,592

(22) Filed: Apr. 20, 2012

(30) Foreign Application Priority Data
Apr. 21, 2011 (JP) 2011-095405

(51) Int. Cl. G11B 7/09; G11B 7/08; G11B 7/1374

(52) U.S. Cl. 720/681; 369/112.23; 369/44.37; G9B/7.121; G9B/7.041; G9B/7.062

(57) ABSTRACT

Stable performance of additional recording and erasing and rewriting operations is allowed regardless of a change in inclination of a guide layer separable optical disc. An optical pickup device includes an angle variable reflection mirror (an optical axis angle variable element) which changes directions of optical axes of first and second light beams when the first light beam for recording or reproduction and the second light beam for servo signal detection are emitted from laser diodes and incident upon the optical disc through an objective lens. When additional recording is performed on the optical disc, the optical axis angle of the angle variable reflection mirror is adjusted such that a tracking error signal detected from a record layer with the first light beam is reduced to almost zero while tracking control is being performed on a guide layer with the second light beam.

### CLAIM OF PRIORITY

The present application claims priority from Japanese patent application serial No. JP2011-095405, filed on Apr. 21, 2011, the content of which is hereby incorporated by reference into this application.

### BACKGROUND OF THE INVENTION

(1) Field of the Invention

The present invention relates to optical pickup device and optical disc apparatus which favorably record and reproduce information onto and from a guide layer separable optical disc which includes a plurality of record layers and in which a guide layer is separated from the record layers.

(2) Description of the Related Art

Recently, for further increasing the capacity of an optical disc, a multi-layer disc which is configured by piling up a plurality of record layers in order to record information on one optical disc has been studied. In addition, in the multi-layer disc, a system (a guide layer separable system) configured such that a layer (a guide layer) on which a servo signal is recorded is installed independently of the respective record layers and servo control of the respective record layers is performed by using the guide layer is also proposed. In a guide layer separable optical disc as mentioned above, when the disc is inclined, a guide track on the guide layer and a recording mark (a pit) on each record layer are out of alignment with each other in relative positional relation. As a result, such a problem may occur that in the case that additional recording is to be performed after recording has been performed along the guide track, if the inclination of the disc is changed, for example, in mounting a drive, information will be additionally recorded again on a track on which recording has been already performed and hence already recorded information will be destroyed.

In order to solve the above mentioned problem, it is described in Japanese Patent Application Laid-Open No. 2010-40093 that “in order to appropriately perform additional recording without destroying already recorded information”, “an additional recording start position which follows a recorded area (on which information has been already recorded) on a record layer is detected and an irradiation spot of a first laser beam for servo operation is moved from the additional recording start position to a position on the guide track opposite to a position which is separated from the additional recording start position toward an unrecorded area (on which information is not yet recorded) when additional recording is to be started so as to follow-up-move an irradiation spot of a second laser beam for information recording or reproduction which is directed onto the record layer, and additional recording onto the record layer is started from a position of the irradiation spot of the second laser beam which is obtained after follow-up movement”.

### SUMMARY OF THE INVENTION

According to a technique disclosed in Japanese Patent Application Laid-Open No. 2010-40093, the position of the spot of the light beam for recording is follow-up-moved by moving the spot of the light beam for servo signal detection up to a position where any information is not yet recorded relative to the guide track of the guide layer, thereby to avoid additional recording on the same position. This follow-up recording method is devised in order not to destroy recorded information by avoiding additional recording on the same position. However, it is difficult for this method to repetitively scan the position which is the same as that of the recorded area (a record pit). As a result, such a problem may occur that it is difficult to perform a recorded information erasing operation or an information rewriting operation on a rewritable disc and hence it is difficult to apply this method to the rewritable disc. In addition, when additional recording is to be performed, a discontinuous part (an unrecorded area) is formed between a point at which recording is again started and the recorded area. Thus, such problems may occur that the recording capacity of the disc is lost and tracking control is not smoothly performed.

Therefore, an object of the present invention is to provide optical pickup device and optical disc apparatus which allow stable performance of an erasing operation and a rewriting operation in addition to additional recording regardless of a change in inclination of a guide layer separable optical disc.

The above mentioned object may be attained by the invention described in the appended patent claims. According to one embodiment of the present invention, there is provided an optical pickup device which records and reproduces information on and from, or records or reproduces information on or from an optical disc in which a record layer on which information is recorded is separated from a guide layer which generates a servo signal, and includes a first laser diode which emits a first light beam used for information recording or reproduction on or from the record layer, a second laser diode which emits a second light beam used for servo signal detection from the guide layer, an objective lens which irradiates the record layer of the optical disc with the first light beam and the second light beam, a first detector which receives the first light beam reflected from the optical disc, a second detector which receives the second light beam reflected from the optical disc, and an optical axis angle variable element which changes the direction of an optical axis of at least one of the first and second light beams which are incident from the objective lens upon the optical disc.

According to another embodiment of the present invention, there is provided an optical disc apparatus on which the optical pickup device is loaded and which includes a laser lighting circuit which supplies driving currents to the first and second laser diodes, an information signal recording circuit which supplies an information signal to be recorded on the record layer of the optical disc via the laser lighting circuit, an information signal reproduction circuit which reproduces the information which is recorded on the record layer of the optical disc from a signal detected by the first detector, a servo signal generation circuit which generates servo signals for use in focusing control and tracking control from signals recorded on the record layer and the guide layer of the optical disc which have been detected by the first and second detectors, and an optical axis angle variable element drive circuit which adjusts the angle of the optical axis of the optical axis angle variable element, wherein the optical axis angle variable element drive circuit adjusts the angle of the optical axis of the optical axis angle variable element such that a tracking error signal which is detected from the record layer by the first detector is reduced to almost zero in a state that tracking control is being performed on the basis of a signal which is detected from the record layer by the second detector.

According to the present invention, there may be provided optical pickup device and optical disc apparatus which allow stable performance of an erasing operation and a rewriting operation in addition to additional recording regardless of a change in inclination of a guide layer separable optical disc.

### BRIEF DESCRIPTION OF THE DRAWINGS

These and other features, objects and advantages of the present invention will become more apparent from the following description when taken in conjunction with the accompanying drawings wherein:

FIG. 1 is a diagram illustrating a configuration of a first embodiment of an optical pickup device;

FIG. 2 is a schematic diagram illustrating a configuration of an optical disc apparatus on which an optical pickup device is loaded;

FIG. 3 is a flowchart illustrating adjustment for optimizing an angle of an optical axis of an optical axis angle variable element;

FIG. 4 is a graph illustrating a relation between a disc inclination angle (or an optical axis angle) and a tracking error signal;

FIG. 5 is a flowchart illustrating a recording operation in an optical disc apparatus;

FIG. 6 is a flowchart illustrating an erasing operation in an optical disc apparatus;

FIG. 7 is a diagram illustrating a configuration of a second embodiment of the optical pickup device;

FIG. 8 is a diagram illustrating a configuration of a third embodiment of the optical pickup device;

FIG. 9 is a diagram illustrating a configuration of a fourth embodiment of the optical pickup device;

FIG. 10 is a diagram illustrating a configuration of a fifth embodiment of the optical pickup device;

FIG. 11 is a diagram illustrating a configuration of a sixth embodiment of the optical pickup device; and

FIG. 12 is a diagram illustrating a configuration of a seventh embodiment of the optical pickup device.

### DETAILED DESCRIPTION OF THE EMBODIMENTS

Hereinafter, embodiments of the present invention will be described with reference to the accompanying drawings. In the following embodiments, description will be made in relation to a guide layer separable optical disc which includes a plurality of record layers and in which a guide layer is separated from the record layers. An optical system of an optical pickup device includes an optical system (hereinafter, referred to as an “optical system for recording”) which emits a light beam for recording or reproduction to a record layer of an optical disc and detects a signal from the record layer and an optical system (hereinafter, referred to as an “optical system for servo operation” which detects a signal from a guide layer and supplies the signal to a servo control unit. Then, an optical axis angle variable element which adjusts the angle of an optical axis of a light beam which is incident upon the optical disc is installed in both or one of the optical system for recording and the optical system for servo control such that even when the inclination of the optical disc is changed, the angle of the optical axis may be adjusted coping with a change in inclination.

### First Embodiment

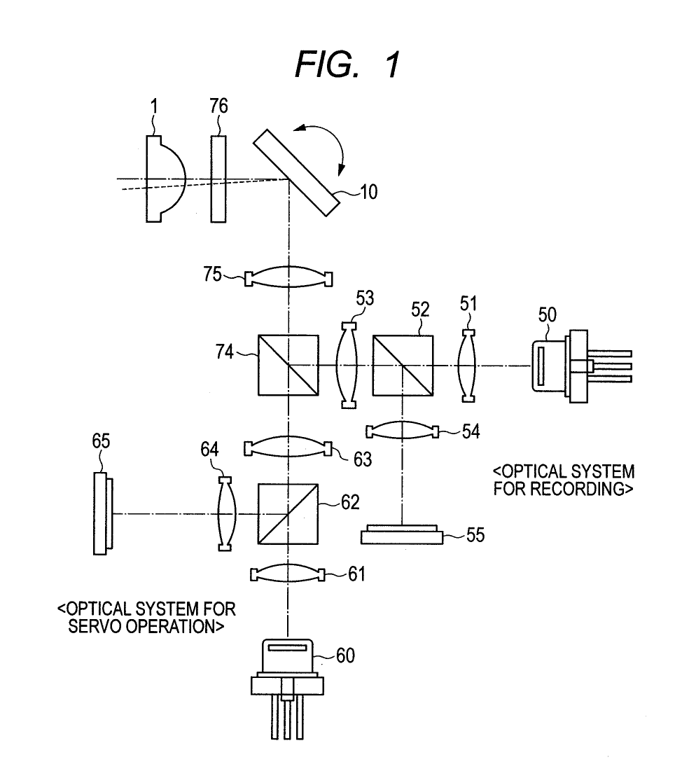

FIG. 1 is a diagram illustrating a configuration of an optical system relating to a first embodiment of an optical pickup device according to the present invention. First, an optical system for recording which detects a signal from a record layer will be described. A first light beam (used for recording or reproduction) is emitted from a laser diode 50. When an optical disc which is actually used is a BD (Blur-ray Disc), the wavelength of the first light beam is 405 nm. The first light beam is converted to almost collimated light rays by a lens (a collimating lens) 51. Then, the light beam which has been transmitted through the lens 51 is incident upon an angle variable reflection mirror 10 through a polarization beam splitter (PBS) prism 52, a lens 53, a dichroic prism 74 and a lens 75. As described later, the angle variable reflection mirror 10 is an optical axis angle variable element which changes the angle of the mirror to change the direction of an optical axis of reflected light. The light beam which has been reflected from the angle variable reflection mirror 10 is transmitted through a ¼ wavelength plate 76 and is concentrated on a predetermined record layer of the optical disc (not illustrated) through an objective lens 1 which is loaded on an actuator.

The light beam which has been reflected from the predetermined record layer of the optical disc is incident upon a lens 54 via the objective lens 1, the ¼ wavelength plate 76, the angle variable reflection mirror 10, the lens 75, the dichroic prism 74, the lens 53 and the PBS prism 52. In the lens 54, the light beam is astigmatized and is detected by a detector 55, by which PDP (Differential Phase Detection) signals for a focusing error signal and a tracking error signal and information signals are detected by an astigmatic method.

Next, respective constitutional elements will be described. The PBS prism 52 is a prism which has polarization characteristics in transmittance and reflectance and transmits a light beam emitted from the laser diode 50 and reflects a light beam reflected from a disc. The lens 53 is movable in an optical axis direction and is combined with the lens 75 to change a divergent state and/or a convergent states of light beams which are incident upon the objective lens 1, thereby correcting spherical aberration which would occur due to a difference in distance (a thickness of a substrate) from a surface of the disc among a plurality of record layers. In addition, the dichroic prism 74 has such a wavelength selecting property that it reflects the first light beam emitted from the laser diode 50 and transmits a second light beam emitted from a laser diode 60 which will be described later in the first embodiment. It is preferable that the detector 55 be configured to receive a beam reflected from the disc by dividing it into at least four beams in order to detect the DPD signal for the tracking error signal. Although the astigmatic method is adopted as a focusing error signal detecting method, other methods such as a knife edge method and a spot size method may be adopted.

Next, an optical system for servo operation which detects a signal on a guide layer will be described. The second light beam (for servo operation) is emitted from the laser diode 60. The wavelength of the second light beam is different from that of the first light beam and is, for example, 650 nm. The second light beam is converted to almost collimated light rays by a lens (a collimating lens) 61. Then, the light beam which has been transmitted through the lens 61 is incident upon the angle variable reflection mirror 10 through a PBS prism 62, a lens 63, the dichroic prism 74 and the lens 75. As described above, the angle variable reflection mirror 10 changes its angle to change a direction of an optical axis of reflected light as in the case of the first light beam. The light beam which has been reflected from the angle variable reflection mirror 10 is transmitted through the ¼ wavelength plate 76 and is concentrated on the guide layer of the optical disc through the objective lens 1 which is loaded on the actuator.

The light beam reflected from the guide layer of the optical disc is incident upon a lens 64 through the objective lens 1, the ¼ wavelength plate 76, the angle variable reflection mirror 10, the lens 75, the dichroic prism 74, the lens 63, and the PBS prism 62. In the lens 64, the light beam is astigmatized and then detected by a detector 65, by which a focusing error signal and a tracking error signal are detected by an astigmatic method. In the above mentioned case, it is preferable that the detected tracking error signal be a push-pull signal when the guide layer is of a groove structure and be a DPD signal when the guide layer is of a pit structure.

Next, respective constitutional elements will be described. The PBS prism 62 is a prism which has polarization properties in transmittance and reflectance and transmits a light beam emitted from the laser diode 60 and reflects a light beam reflected from the disc. The lens 63 is movable in an optical axis direction and is combined with the lens 75 to change a divergent state and/or a convergent state of light beams which are incident upon the objective lens 1, thereby correcting relative defocusing which would occur due to a difference in distance between each record layer to which and from which information is be recorded and reproduced and the guide layer.

In the optical system according to the first embodiment, the angle variable reflection mirror 10 is loaded as an optical axis angle variable element so as to adjust optical axes of both the optical system for recording and the optical system for servo operation. As the angle variable reflection mirror, for example, an MEMS (Micro Electro Mechanical Systems) mirror is favorably used. With the use of an MEMS mirror as mentioned above, when the current inclined state of the disc changes from an inclined state obtained in former recording (when information has been recorded before), it is allowed to change the angle of the reflection mirror 10 conforming to an amount of change in inclined state, thereby reproducing an incident angle of the beam upon the disc obtained in former recording. Since the position which is the same as that of a bit on which recording has been already performed may be scanned by performing correction as mentioned above, stable erasing and rewriting operations may be performed on the disc such as, for example, a rewritable disc. In additional recording, it is allowed to record new information continuously from a previously recorded area (on which information has been recorded before) and hence any unrecorded area is not formed.

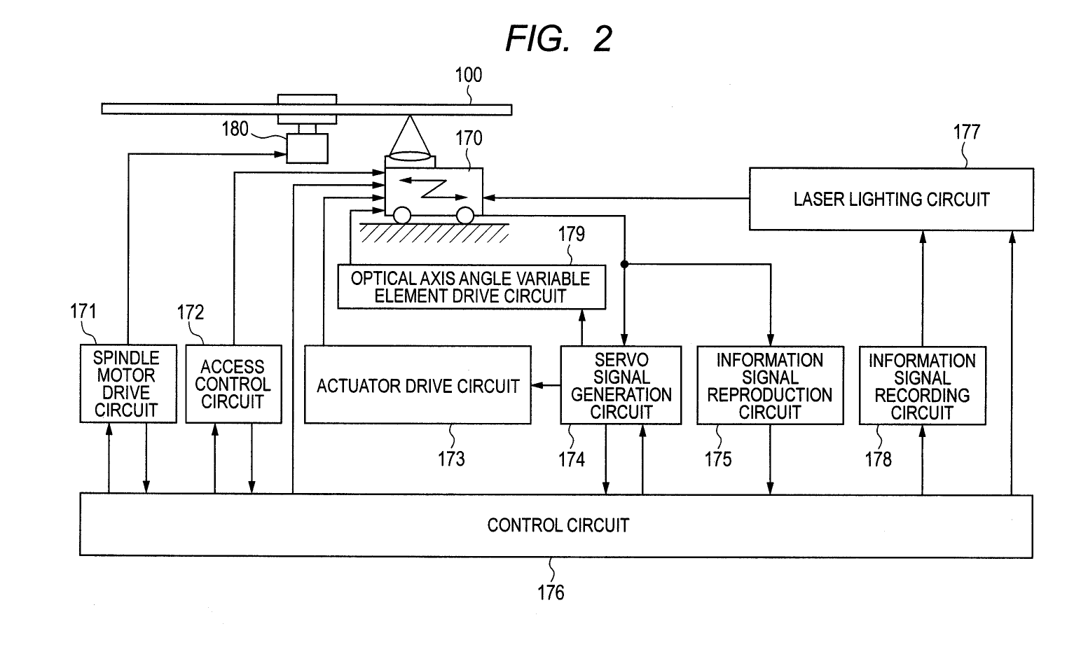

FIG. 2 is a schematic diagram illustrating a configuration of an optical disc apparatus on which the optical pickup device according to the first embodiment is loaded. An optical pickup device 170 includes a mechanism which drives it along a radius direction of an optical disc 100 and is position-controlled in accordance with an access control signal from an access control circuit 172. Predetermined laser drive currents are supplied from a laser lighting circuit 177 to the laser diodes 50 and 60 in the optical pickup device 170 in accordance with a recording or reproducing operation and the first and second light beams of predetermined quantities of light are emitted from the laser diodes 50 and 60. When recording information, the laser lighting circuit 177 controls lighting on the basis of a record control signal from an information signal recording circuit 178 to write desired information onto the optical disc 100. Alternatively, the laser lighting circuit 177 may be incorporated into the optical pickup device 170.

Signals output from the detectors 55 and 65 in the optical pickup device 170 are sent to a servo signal generation circuit 174 and an information signal reproduction circuit 178. In the servo signal generation circuit 174, servo signals for a focusing error signal, a tracking error signal, a tilt control signal and the like are generated on the basis of the signal output from the detector 55, a servo signal for a tracking error signal is generated on the basis of the signal output from the detector 65, and the actuator in the optical pickup device 170 is driven by an actuator drive circuit 173 on the basis of the generated servo signals to control the position and the attitude of the objective lens 1. In addition, in the servo signal generation circuit 174, an optical axis angle error signal is generated on the basis of the tracking error signal output from the detector 55 and the optical axis angle variable element (the angle variable reflection mirror 10) in the optical pickup device 170 is driven by an optical axis angle variable element drive circuit 179 on the basis of the generated optical axis angle error signal to adjust the optical axis angle of the element. In the information signal reproduction circuit 175, an information signal which is recorded on the optical disc 100 is reproduced on the basis of the signal output from the detector 55.

Some of the signals obtained from the servo signal generation circuit 174 and the information signal reproduction circuit 175 are sent to a control circuit 176. A spindle motor drive circuit 171, the access control circuit 172, the servo signal generation circuit 174, the laser lighting circuit 177, the information signal recording circuit 178 and the like are connected to the control circuit 176 to control rotation of a spindle motor 180 which rotates the optical disc 100, to control an access direction and an access position, to servo-control the objective lens in the optical pickup device 170, to control light emission from the laser diodes and to control other operations.

Although the configuration of the optical disc apparatus for information recording and reproduction has been described as mentioned above, an optical disc apparatus the operational function of which is limited to an information reproducing operation may be similarly implemented by eliminating the information signal recording circuit 178. In addition, it goes without saying that with respect to the optical pickup device 170 to be loaded on the optical disc apparatus, the pickup device either of the configuration according to the first embodiment or of other configurations (second to seventh embodiments) which will be described below are applicable.

Next, adjustment of the optical axis angle of the optical axis angle variable element (the angle variable reflection mirror 10) in the optical pickup device 170 will be described.

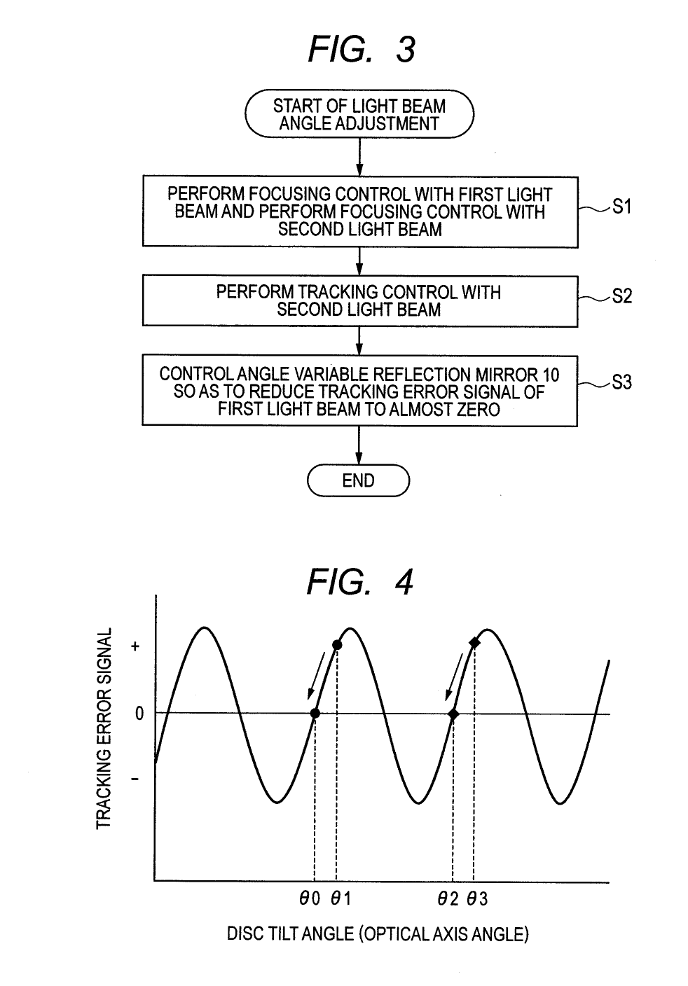

FIG. 3 is a flowchart illustrating adjustment for optimizing an optical axis angle of an optical axis angle variable element (here, the angle variable reflection mirror 10). First, focus control is performed on a target record layer of an optical disc with a first light beam (emitted from the laser diode 50) of the optical system for recording. Specifically, the objective lens 1 is driven in a focusing direction by the servo signal generation circuit 174 and the actuator drive circuit 173 while a focusing error signal is being detected by the detector 55 to converge the first light beam on the target record layer (Step S1). Similarly, focus control is performed on a guide layer of the optical disc with a second light beam (emitted from the laser diode 60). Specifically, the lens 63 is driven in an optical axis direction while a focusing error signal is being detected by the detector 65 to converge the second light beam on the guide layer (Step S1). Then, tracking control is performed on the guide layer of the optical disc with the second light beam (emitted from the laser diode 60) of the optical system for servo operation. Specifically, the objective lens 1 is driven in a tracking direction by the servo signal generation circuit 174 and the actuator drive circuit 173 while a tracking error signal is being detected by the detector 65 to make the second light beam track a guide track of the guide layer (Step S2).

Next, in this state, in a recorded area of the target record layer, a tracking error signal for a recorded pit array is detected by the detector 55 with the first light beam. Then, the optical axis angle (a tilt of the optical axis in a disc radius direction) of the angle variable reflection mirror 10 is adjusted by the servo signal generation circuit 174 and the optical axis angle variable element drive circuit 179 so as to reduce the tracking error signal which has been detected with the first light beam to almost zero (Step S3). In the above mentioned situation, tracking control which has been performed on the guide layer with the second light beam in Step S2 is continuously performed. Owing to the above mentioned operation, it is allowed to match the current incident angle of the light beam which is incident upon the disc with an incident angle obtained in former recording.

FIG. 4 is a graph illustrating a relation between a tilt angle of a disc (or an optical axis angle) and a tracking error signal. The horizontal axis is the tilt angle of the disc or the optical axis angle of the angle variable reflection mirror 10. An incident angle of a light beam which is incident upon the disc is changed with a change in one of the tilt angle and the optical axis angle. In the above mentioned situation, since the second light beam tracks the guide track of the guide layer, the first light beam moves in a direction transversal to a record track of the record layer. As a result, a tracking error signal (a DPD signal) is detected by the detector 55. It is assumed that θ0 is a disc tilt angle obtained in former recording, θ1 is the current disc tilt angle, and an optical axis direction of the angle variable reflection mirror 10 is the same as that obtained in former recording. If the current disc tilt angle θ1 is equal to the former disc tilt angle θ, the tracking error signal will be reduced to zero. If the tilt angle of the disc changes from θ0 to θ1, the first light beam deviates from a record pit position and hence a tracking error signal according to an amount of change in angle will generate. Thus, the optical axis angle of the angle variable reflection mirror 10 is adjusted so as to reduce the tracking error signal to zero. In the above mentioned case, if the optical axis direction is tilted by a difference in disc tilt angle Δθ=θ0−θ1, the tracking error signal will be reduced to zero and hence it is allowed to match the current incident angle of the light beam which is incident upon the disc with the incident angle obtained in former recording.

When the amount of change in disc tilt angle still remains large in spite of adjustment as mentioned above, it may be sometimes difficult to make the current incident angle of the light beam match with the former incident angle. For example, in the example illustrated in FIG. 4, it is assumed that the current disc tilt angle has been changed up to the position of θ3 relative to the former disc tilt angle θ0. This amount of change in tilt angle corresponds to a tilt angle at which the position of the track of the guide layer is out of alignment with the position of the pit array of the corresponding record layer by one or more tracks. If the optical axis angle is adjusted in the above mentioned situation, the optical axis angle will be adjusted by a difference in disc tilt angle Δθ=θ2−θ3 corresponding to a change from the current position θ3 to a position θ2 where the tracking error signal is reduced to zero. However, the incident angle of the light beam obtained at the position θ2 is in a state that it deviates by one track unlike the state of the incident angle (at the position θ0) obtained in former recording. If the amount of change in tilt angle of the disc is larger than above, the optical axis angle will be adjusted to a state that it deviates by two or more tracks.

However, even when the optical axis angle is adjusted to an n-track (n is an integer)-deviated state as mentioned above, since a beam for recording and reproduction scans the track of the guide layer typically in a state that it deviates by the n track, it is allowed to still maintain a distance between tracks which is obtained in former recording as a distance between tracks on which information is to be recorded or from which information is to be reproduced. In the above mentioned case, it is allowed to normally perform additional recording and rewriting (erasing) by detecting a boundary between a recorded area and an unrecorded area, that is, a recording start position from a reproduction signal of the record layer.

The following method may be introduced in order to eliminate a deviation of the n track occurred in the above adjustment so as to favorably match the current incident angle of the light beam which is incident upon the disc with the incident angle obtained in former recording in adjustment of the optical axis angle.

When a signal is to be recorded on a record layer, information with which synchronization with the guide track of the guide layer would be allowed is additionally recorded in advance. For example, address information is described on the guide track of the guide layer and address information of the corresponding guide track is additionally recorded on a record track of the record layer. In adjusting the optical axis angle, the address information of the corresponding guide track is read out from the record track and the angle variable reflection mirror 10 is adjusted so as to match the read address with the address of the current guide track. Owing to the above mentioned operation, it is allowed to set a correspondence between the track of the guide layer and the pit array of the record layer so as to favorably match the current incident angle of the light beam which is incident upon the disc with the incident angle obtained in former recording.

The above mentioned adjustment of the optical axis angle is performed throughout one rotation (one cycle) of the disc. If the disc is attached along the radius direction, the tilt angle of the disc may be sometimes maintained constant regardless of its rotating position. If the disc is attached in a state that it is inclined toward the spindle, face deflection of the disc will generate and the tilt angle of the disc will be changed depending on the rotating position. In the latter case, the reflection mirror 10 needs only be driven such that the optical axis angle is changed almost sine-functionally in synchronization with a rotational phase of the disc.

The optical axis angle is adjusted in a recorded area of the record layer. Although any tracking error signal is detected in an unrecorded area of the record layer, the state of the optical axis of the reflection mirror 10 which has been adjusted in the recorded area is maintained also in the unrecorded area to set the incident angle so as to be the same as that in the recorded area.

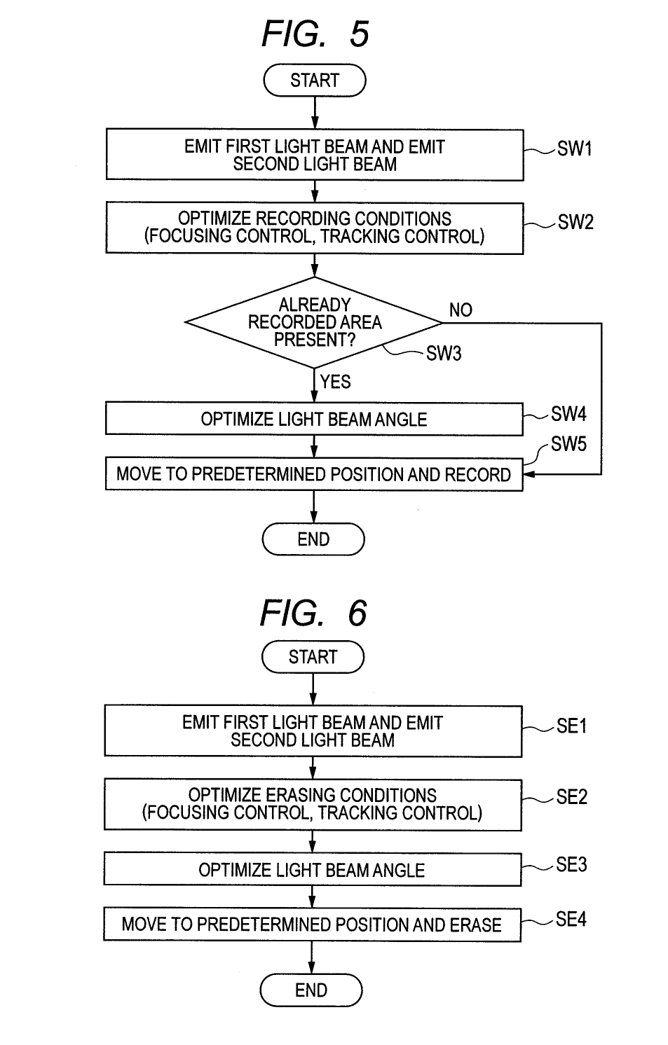

FIG. 5 is a flowchart illustrating a recording operation in an optical disc apparatus. Here, a flow of a recording operation performed on a guide layer separable disc by the optical disc apparatus in FIG. 2. The recording operation is started in response to an instruction from the control circuit 176. First, the spindle motor 180 is driven to rotate the optical disc 100 and the laser lighting circuit 177 lights the laser diodes 50 and 60 in the optical pickup device 170. A first light beam is emitted from the laser diode 50 and a second light beam is emitted from the laser diode 60 (Step SW1). The servo signal generation circuit 174 and the actuator drive circuit 173 detect a focusing error signal with the first light beam to perform focus control on a record layer. In addition, the circuits 174 and 173 detect a tracking error signal with the second light beam to perform tracking control on a guide layer. Further, recording condition optimization such as adjustment of recording power, correction of a spherical aberration by the lens 53 and correction of a tilt of the objective lens 1 are performed using predetermined areas of the record layer (Step SW2). Then, the control circuit 176 determines whether a recorded area is present on the disc (Step SW3).

When the recorded area is present on the disc, the incident angle of the light beam which is incident upon the disc is optimized by the optical axis angle variable element drive circuit 179. Here, the optical axis angle of the angle variable reflection mirror 10 is optimized so as to reduce the tracking error signal which has been detected with the first light beam to zero as described with reference to FIG. 3, thereby matching the incident angle of the light beam which is incident upon the disc with the incidence angle of the light beam upon the recorded area. Incidentally, in angle adjustment, it is allowable that the track of the guide layer deviates from the pit array of the corresponding record layer by the n (an integer) track (Step SW4). Then, under the conditions so optimized, position control is performed on the pickup device 170 and tracking control is performed on the guide track with the second light beam by the access control circuit 172 and the actuator drive circuit 173 so as to move the first light beam to a desirable recording start position on the record layer. In the above mentioned case, if the track of the guide layer deviates from the pit array of the corresponding record layer by the n track, the recording start position will be corrected by this amount of deviation. Then, information is recorded on the disc with the first light beam by the information signal recording circuit 178 (Step SW5). In the recording operation, either additional recording or rewrite (overwrite) recording may be performed on the recorded area.

When the recorded area is not present on the disc in determination in Step SW3, the incident angle of the light beam is not optimized and the process proceeds to Step SW5. Then, the first light beam is moved to a desired recording start position on the record layer by performing tracking control on the guide track with the second light beam as it is and the information is recorded on the disc with the first light beam.

FIG. 6 is a flowchart illustrating an erasing operation in the optical disc apparatus. Basically, the flow of the erasing operation is obtained by replacing the recording operation with the erasing operation. Since the erasing operation is performed on the assumption that a recorded area is present on a record layer, determination as to presence/absence of the recorded area (Step SW3) in FIG. 5 is eliminated.

The erasing operation is started in response to an instruction from the control circuit 176. First, a disc is rotated to emit a first light beam from the laser diode 50 and to emit a second light beam from the laser diode 60 (Step SE1). Focus control is performed on a record layer with the first light beam and tracking control is performed on a guide layer with the second light beam. Erasing condition optimization such as adjustment of erasing power, correction of spherical aberration by the lens 53, correction of a tilt of the objective lens 1 and others is performed using predetermined areas of the record layer (Step SE2).

Then, the incident angle of the light beam which is incident upon the disc is optimized by the optical axis angle variable element drive circuit 179. In optimization, the optical axis angle of the angle variable reflection mirror 10 is adjusted in the same manner as that in Step SW4 in the recording operation in FIG. 5, thereby matching the incident angle of the light beam which is incident upon the disc with the incident angle obtained in former recording (Step SE3). Although it is optimum to adjust the angle at a radial position where erasing is performed, the angle may be adjusted at another radial position.

Position control is performed on the pickup device 170 and tracking control is performed on the guide track with the second light beam under the above mentioned optimized condition to move the first light beam to a desired erasing start position on the record layer. Then, information which is recorded on the disc is erased with the first light beam (used for erasing) (Step SW5).

As described above, in the first embodiment, stable recording operation (additional recording and rewrite recording) and erasing operation may be performed on the guide layer separable optical disc by loading the angle variable reflection mirror 10 on the optical pickup device and optimizing the incident angle of the light beam which is incident upon the disc. That is, even if the tilt angle of the optical disc is changed from the tilt angle obtained in former recording, the position of the recorded track may be scanned again with accuracy. Thus, recorded information is not destroyed and any unrecorded area is not formed at a position where recording is restarted.

In addition, according to the first embodiment, such another effect may be obtained that information is recorded and reproduced by allocating a plurality of tracks of a record layer to one guide track of the guide layer. This effect is brought about by utilizing such a situation that a position where recording is performed with the first light beam deviates by a predetermined amount in a radial direction of the disc in a state that the second light beam is scanning one guide track of the guide layer by offsetting the angle of the angle variable reflection mirror 10 from an optimum position by a predetermined amount after the optical axis angle has been optimized as illustrated in FIG. 3. As a result, positioning of one guide track of the guide layer onto the plurality of tracks of the record layer is allowed by switching the offset amount of the angle of the mirror 10. In an existing method, although it may be imagined to implement the above mentioned operation by giving the offset amount to a tracking error signal, stable tracking control may not be performed. Particularly, the tracking error signal has a maximum value at a position deviating from the guide track by a ¼ track pitch and hence it is difficult to perform tracking control at that position. In the first embodiment, since control needs only be performed at a position where the tracking error signal is reduced to zero as in the case of existing tracking control, stable tracking control may be performed. In addition, since the plurality of tracks of the record layer may be controlled by one guide track, the numerical aperture of the objective lens on which the second light beam for the guide layer is concentrated may be reduced. As a result, such an effect may be also obtained that the influence of spherical aberration and defocusing is reduced and hence the tracking error signal which is detected with the second light beam is stabilized.

As a further effect, when the optical axis of the objective lens deviates in the radial direction of the disc, the deviation may be corrected. For example, even when a difference in tilt of the optical axis occurs between the first and second light beams owing to a variation in manufacture, it is allowed to concentrate the first and second light beams on predetermined positions by tilting their optical axes as in the first embodiment.

The configuration of the first embodiment may be altered as follows. Although in the first embodiment, the tracking error signal of the record layer is monitored in order to adjust the optical axis angle of the angle variable reflection mirror 10, levels of reproduction signal and address signal which have been detected from the record layer may be monitored. In addition, although a case in which the guide track is formed on the guide layer of the disc has been described, a disc on which a pit used for guiding is formed may be used.

Although the angle variable reflection mirror 10 (for example, an MEMS mirror) is used to tilt the optical axis of the beam which is incident upon the disc in the optical system of the first embodiment, any element may be used as long as it is of the type that the angle of reflected light is changed. Although aberration occurs in the objective lens by tilting the optical axis, the aberration may be corrected, for example, by inclining the objective lens.

Although the angle variable reflection mirror 10 is disposed on the round route of the optical system, it may be disposed only on the outbound route. However, since a light beam on a detector may move to make is difficult to detect a signal when the mirror is disposed only on the outbound route, it is desirable to dispose the mirror in the optical path of the round route.

Although the optical axis angle of the angle variable reflection mirror 10 is adjusted to be optimized every time the recording operation or the erasing operation is to be performed in the first embodiment, only the first adjustment may be performed and later adjustment to be performed when the operation is switched may be omitted as long as an inclined state of a once attached disc does not change.

### Second Embodiment

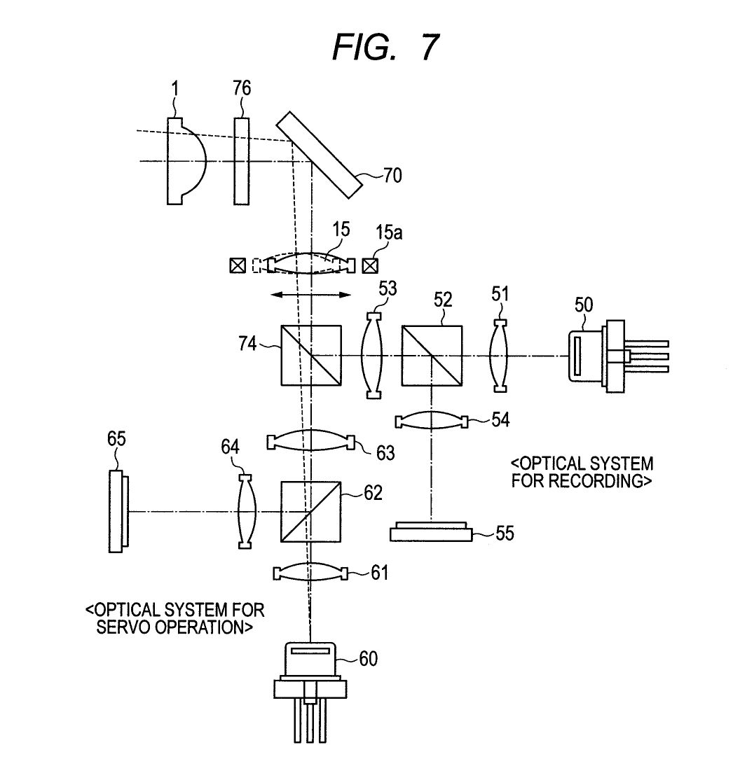

FIG. 7 is a diagram illustrating a configuration of an optical system relating to a second embodiment of the optical pickup device of the present invention. Although the angle variable reflection lens 10 is used as the optical axis angle variable element in the first embodiment (FIG. 1), the second embodiment is configured such that a movable lens 15 which is drivable in a direction orthogonal to an optical axis direction and in a radius direction of a disc so as to change an incident angle of a light beam which is incident upon the disc. That is, the lens 75 in FIG. 1 is replaced with the movable lens 15 and the angle variable reflection mirror 10 is replaced with a stationary reflection mirror 70. With respect to other optical components, the same numerals are assigned to components which have the same functions as those in FIG. 1.

In the second embodiment, the movable lens 15 and a drive mechanism 15a which drives the movable lens 15 are loaded as the optical axis angle variable element. The drive mechanism 15a moves the movable lens 15 in the direction orthogonal to the optical axis direction and in the radius direction (illustrated by an arrow in FIG. 7) of the disc. A magnetic drive mechanism which drives with a current such as, for example, an actuator or the like which drives an objective lens is suited as the drive mechanism 15a. As the movable lens 15 displaces in the radius direction of the disc in convergent/divergent light, the optical axis direction of the movable lens 15 is changed accordingly. Owing to the above mentioned operation, even if a current inclination angle of the disc is changed from an inclination angle obtained in former recording, an incident angle of a light beam which is incident upon the disc and is obtained in former recording may be reproduced by adjusting the position of the movable lens 15 in the radius direction of the disc conforming to a change in inclination angle.

The optical axis angle of the movable lens 15 in the second embodiment is adjusted in the same manner as that by the adjusting method of the first embodiment illustrated in FIG. 3. That is, in Step S3 in FIG. 3, the movable lens 15 needs only be adjusted to move in the radius direction of the disc by the drive mechanism 15a such that a tracking error signal on a record layer which is detected with a first light beam is reduced to almost zero.

Owing to the above mentioned operation, stable erasing and rewriting operations may be performed on a rewritable disc as in the case in the first embodiment. In addition, in additional writing, new information may be recorded continuously from a previously recorded area and hence any unrecorded area may not be formed.

As an alteration of the second embodiment, for example, the lens 53 in the optical system for recording, the lens 63 in the optical system for servo operation and the like may be moved in the radius direction of the disc in place of the movable lens 15 as the optical axis angle variable element. As a result, the incident angle of the light beam which is incident upon the disc may be changed and hence the same effect as the above may be obtained. In particular, when only the lens 63 in the optical system for servo operation is moved, movement acts only on the second light beam with which a signal on a guide layer is detected and does not act on a first light beam with which a signal on a record layer is detected. Thus, aberration caused by a deviation in tilt of the first light beam which is incident upon the objective lens 1 does not occur. Therefore, a system of driving the lens 63 has such an advantage that more stable recording than would be attained by a system of driving the movable lens 15 and/or the lens 53 is performed.

### Third Embodiment

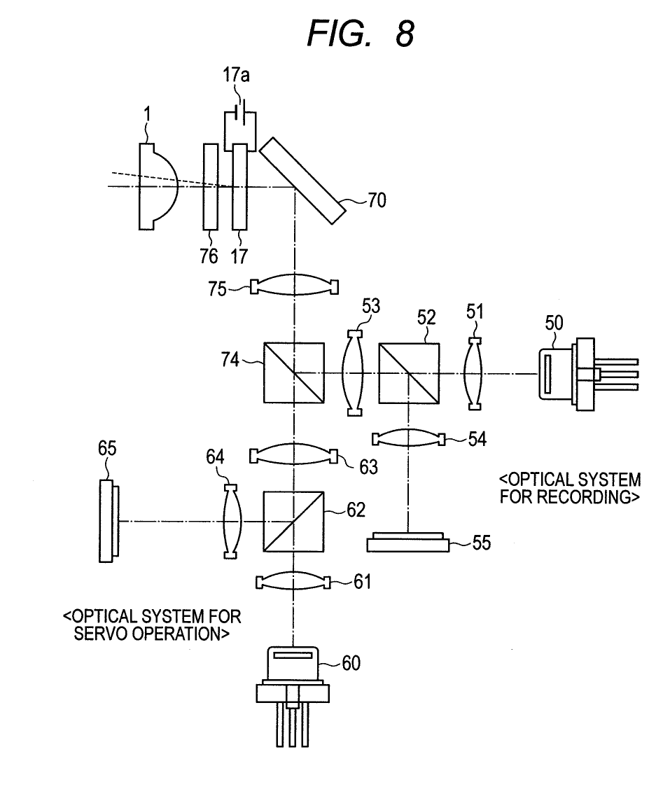

FIG. 8 is a diagram illustrating a configuration of an optical system relating to a third embodiment of the optical pickup device of the present invention. The third embodiment is configured such that a liquid crystal aberration element 17 is used as the optical axis angle variable element so as to change the incident angle of a light beam which is incident upon a disc. In comparison with the configuration of the first embodiment (FIG. 1), the angle variable reflection mirror 10 is replaced with the stationary reflection mirror 70 and the liquid crystal aberration element 17 is loaded between the reflection mirror 70 and the ¼ wavelength plate 76.

In the third embodiment, the liquid crystal aberration element 17 and a voltage application mechanism 17a which applies a voltage to the element 17 are loaded as the optical axis angle variable element. The liquid crystal aberration element 17 is a liquid crystal element the refraction index of which exhibits, for example, a stepped or sloped distribution and changes with application of the voltage. The optical axis of the light beam passing through the liquid crystal aberration element 17 may be tilted by changing the refraction index distribution thereof. As a result, even if the current inclination angle of the disc is changed from an inclination angle obtained in former recording, the incident angle of the light beam which is incident upon the disc and is obtained in former recording may be reproduced by adjusting the voltage applied to the liquid crystal aberration element 17 conforming to a change in inclination angle.

The optical axis angle of the liquid crystal aberration element 17 in the third embodiment is adjusted in the same manner as that by the adjusting method of the first embodiment illustrated in FIG. 3. That is, in Step S3 in FIG. 3, the voltage application mechanism 17a needs only apply an appropriate voltage to the liquid crystal aberration element 17 such that a tracking error signal on a record layer which is detected with a first light beam is reduced to almost zero.

Owing to the above mentioned operation, stable erasing and rewriting operations may be performed on a rewritable disc as in the case in the first embodiment. In addition, in additional recording, new information may be recorded continuously from a previously recorded area and hence any unrecorded area may not be formed.

As an alteration of the third embodiment, the arrangement of the liquid crystal aberration element 17 which is an optical axis angle variable element may be changed. That is, for example, it may be arranged before or behind the lens 75. As another alternation, it may be arranged before and/or behind the lens 63 of the optical system for servo operation. In the above mentioned case, rearrangement of the liquid crystal aberration element 17 acts only on a second light beam with which a signal on a guide layer is detected and does not act on the first light beam with which a signal on a record layer is detected. Thus, aberration caused by a deviation in tilt of the first light beam which is incident upon the objective lens 1 does not occur. Therefore, such an advantage may be attained that recording which is more stable than that performed when it is arranged on an optical path which is commonly used by the optical systems for recording and servo operation is performed.

### Fourth Embodiment

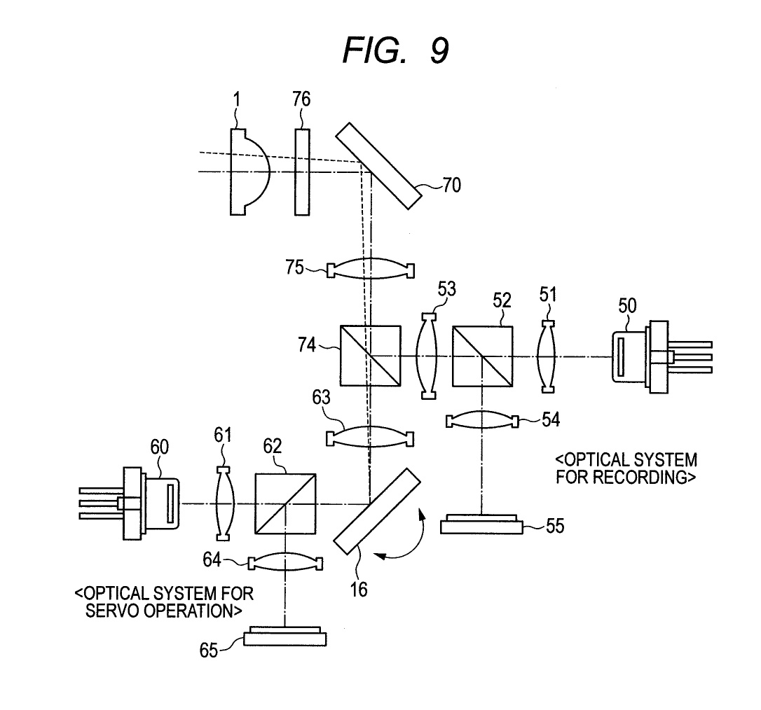

FIG. 9 is a diagram illustrating a configuration of an optical system relating to a fourth embodiment of the optical pickup device of the present invention. Although in the fourth embodiment, an angle variable mirror 16 is used as the optical axis variable element, the fourth embodiment is different from the first embodiment (FIG. 1) in that the angle variable mirror 16 is arranged between the PBS prism 62 and the lens 63 disposed on the optical path of the optical system for servo operation. The angle variable reflection mirror 10 in FIG. 1 is replaced with the stationary reflection mirror 70.

In the fourth embodiment, although the optical axis angle of a second light beam used for servo operation is changed by the angle variable mirror 16, the optical axis angle of a first light beam used for recording is fixed. However, a position where a disc is radially irradiated with the first light beam may be shifted by changing the optical axis angle of the second light beam as in the case in the first embodiment.

The optical axis angle of the angle variable mirror 16 in the fourth embodiment is adjusted in the same manner as that by the adjusting method of the first embodiment illustrated in FIG. 3. That is, in Step S3 in FIG. 3, the optical axis angle of the angle variable mirror 16 needs only be adjusted such that a tracking error signal on a record layer which is detected with the first light beam is reduced to almost zero.

In the fourth embodiment, since a change in optical axis angle of the angle variable mirror 16 has no influence on the incident angle of the first light beam which is incident upon a disc and is used for detection of a signal on a record layer, such an advantage may be obtained that aberration caused by a deviation in tilt of the first light beam for recording does not occur and hence recording and reproducing operations which are more stable than those in the first embodiment are performed.

### Fifth Embodiment

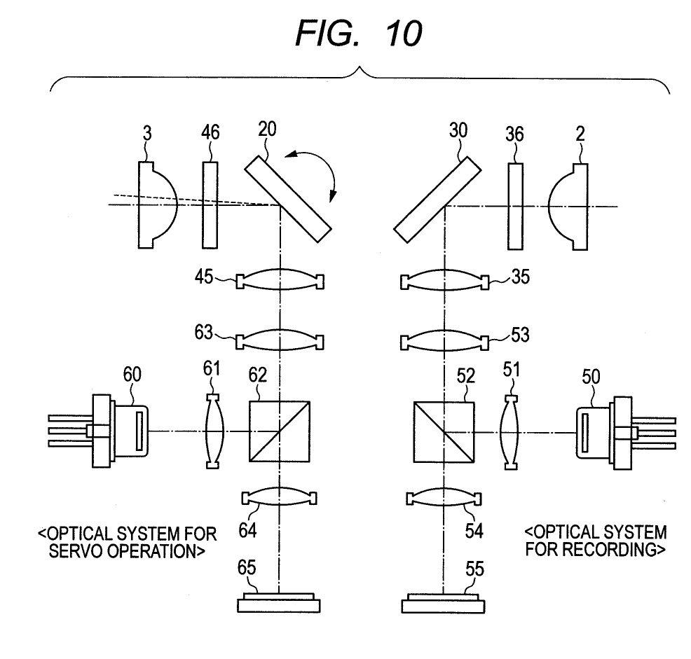

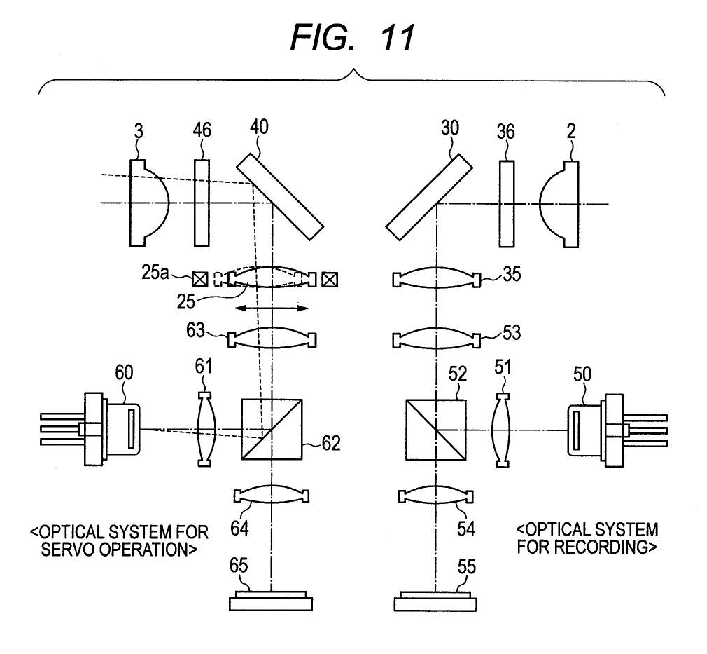

FIG. 10 is a diagram illustrating a configuration of an optical system relating to a fifth embodiment of the optical pickup device of the present invention. In the fifth embodiment, an optical system for recording is favorably separated from an optical system for servo operation and an angle variable reflection mirror 20 is used as the optical axis angle variable element. The fifth embodiment is different from the first embodiment (FIG. 1) in that the angle variable reflection mirror 20 is loaded only on the optical system for servo operation and a stationary reflection mirror 30 is loaded on the optical system for recording. As a result, the dichroic prism 74 in FIG. 1 is eliminated and optical components ranging from the lens 75 to the objective lens 1 which are commonly used in the optical systems for recording and servo operation are divided into a set of components including a lens 35 to an objective lens 2 (the optical system for recording) and a set of components including a lens 45 to an objective lens 3 (the optical system for servo operation). Although, in the example illustrated in FIG. 10, outgoing directions of the objective lens 2 and the objective lens 3 are different from each other, the outgoing directions are so illustrated simply for ready understanding of the configuration and light beams are outgoing from the objective lens 2 and the objective lens 3 in the same direction in reality. These two objective lenses may be simultaneously driven by the same actuator or may be driven independently of each other.

In the optical system for recording, a first light beam for recording and reproduction is emitted from the laser diode 50 and is radiated to a record layer of a disc through the objective lens 2. In the above mentioned case, since the stationary reflection mirror 30 is used, the optical axis angle of the first light beam is fixed.

On the other hand, in the optical system for servo operation, a second light beam for servo operation is emitted from the laser diode 60 and is radiated to a guide layer of the disc through the objective lens 3. In the above mentioned case, the optical axis angle of the second light beam is changed by changing the angle of the angle variable reflection mirror 20.

Although the optical axis angle of the first light beam for recording is fixed in the fifth embodiment, a position where the disc is radially irradiated with the first light beam may be relatively shifted by changing the optical axis angle of the second light beam for servo operation.

The optical axis angle of the angle variable reflection mirror 20 in the fifth embodiment is adjusted in the same manner as that by the adjusting method of the first embodiment illustrated in FIG. 3. That is, in Step S3 in FIG. 3, the optical axis angle of the angle variable reflection mirror 20 needs only be adjusted such that a tracking error signal on a record layer which is detected with the first light beam is reduced to almost zero.

Owing to the above mentioned adjustment, stable erasing and rewriting operations may be performed on a rewritable disc as in the case in the first embodiment. In addition, in additional writing, new information may be recorded continuously from a previously recorded area and any unrecorded area may not be formed.

In the fifth embodiment, since a change in optical axis angle of the angle variable reflection mirror 20 has no influence on the incident angle of the first light beam which is incident on the disc and is used for detection of a signal on a record layer, such an advantage may be obtained that aberration caused by a deviation in tilt of the first light beam for recording does not occur and hence recording and reproducing operations which are more stable than those in the first embodiment are performed.

### Sixth Embodiment

FIG. 11 is a diagram illustrating a configuration of an optical system relating to a sixth embodiment of the optical pickup device of the present invention. In the sixth embodiment, optical systems for recording and servo operation are favorably separated from each other as in the fifth embodiment (FIG. 10). The sixth embodiment is configured such that a movable lens 25 is arranged only on the optical system for servo operation as the optical axis angle variable element so as to change the incident angle of a light beam which is incident upon a disc. That is, the lens 45 in FIG. 10 is replaced with the movable lens 25 which is drivable in a direction orthogonal to its optical axis direction and in a radius direction of the disc and the angle variable reflection mirror 20 is replaced with a stationary reflection mirror 40.

A drive mechanism 25a which drives the movable lens 25 is added to the movable lens 25. The drive mechanism 25a moves the movable lens 25 in the direction orthogonal to the optical axis direction and in the radius direction (illustrated by an arrow in FIG. 11) of the disc to change the optical axis direction of the movable lens 25.

The optical axis angle of the movable lens 25 in the sixth embodiment is adjusted in the same manner as that by the adjusting method of the first embodiment illustrated in FIG. 3. That is, in Step S3 in FIG. 3, the movable lens 25 needs only by adjusted by the drive mechanism 25a so as to move in the radius direction of the disc such that a tracking error signal on a record layer which is detected with a first light beam is reduced to almost zero.

Also in the sixth embodiment, since movement of the movable lens 25 has no influence on the incident angle of the first light beam which is incident upon the disc and is used for detection of a signal on a record layer, such an advantage may be obtained that aberration caused by a deviation in tilt of the first light beam for recording does not occur and hence recording and reproducing operations which are more stable than those in the second embodiment are performed.

As an alteration of the sixth embodiment, for example, the lens 63 used in the optical system for servo operation may be driven in the radius direction of the disc in place of the movable lens 25 as the optical axis angle movable element. In this case, the same effect as the above may be obtained.

### Seventh Embodiment

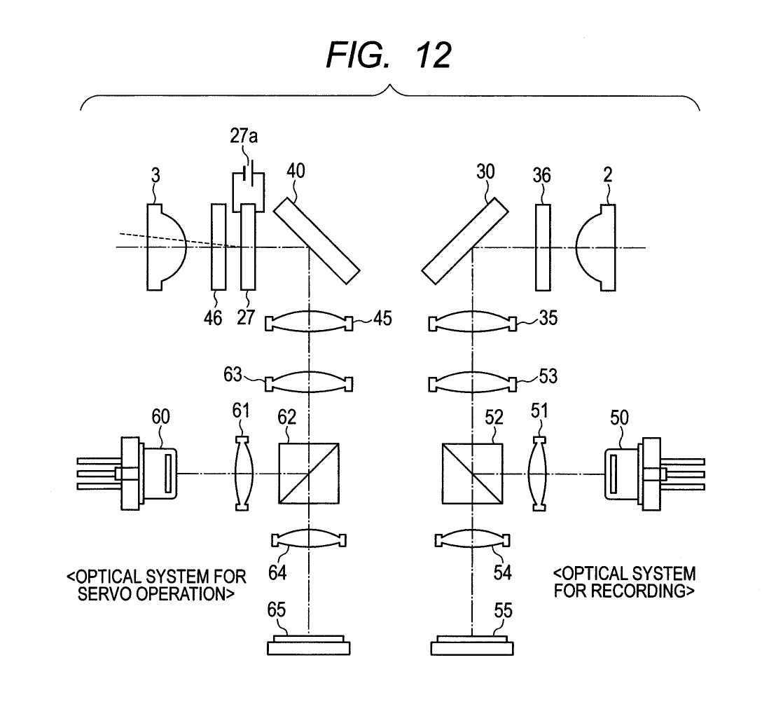

FIG. 12 is a diagram illustrating a configuration of an optical system relating to a seventh embodiment of the optical pickup device of the present invention. In the seventh embodiment, optical systems for recording and servo operation are favorably separated from each other as in the fifth embodiment (FIG. 10). The seventh embodiment is configured such that a liquid crystal aberration element 27 is arranged only on the optical system for servo operation as the optical axis angle variable element so as to change the incident angle of a light beam which is incident upon a disc. That is, in comparison with the configuration in FIG. 10, the angle variable reflection mirror 20 is replaced with the stationary reflection mirror 40 and the liquid crystal aberration element 27 is loaded between the reflection mirror 40 and a ¼ wavelength plate 46.

A voltage application mechanism 27a which applies a voltage to the liquid crystal aberration element 27 is added thereto. The voltage is applied to the liquid crystal aberration element 17 to change a refraction index, thereby changing the direction of an optical axis of a light beam which passes through it.

The optical axis angle of the liquid crystal aberration element 27 in the sixth embodiment is adjusted in the same manner as that by the adjusting method of the first embodiment illustrated in FIG. 3. That is, in Step S3 in FIG. 3, the voltage application mechanism 27a needs only apply an appropriate voltage to the liquid crystal aberration element 27 such that a tracking error signal on a record layer which is detected with a first light beam is reduced to almost zero.

Also in the seventh embodiment, since a change in voltage applied to the liquid crystal aberration element 27 has no influence on the incident angle of the first light beam which is incident upon the disc and is used for detection of a signal on a record layer, such an advantage may be obtained that aberration caused by a deviation in tilt of the first light beam for recording does not occur and hence recording and reproducing operations which are more stable than those in the third embodiment are performed.

As an alteration of the seventh embodiment, a position where the liquid crystal aberration element 27 is arranged may be changed. For example, the liquid crystal aberration element 27 may be arranged before and/or behind the lens 45 and/or the lens 63 of the optical system for servo operation. In this case, the same effect as the above may be obtained.

In each of the above mentioned fifth to seventh embodiments, the optical system is divided into the optical system for recording and the optical system for servo operation, and each of the angle variable reflection 20, the movable lens 25 and the liquid crystal aberration element 27 which serve as the optical axis angle variable element is arranged on the optical path of the optical system for servo operation. However, the present invention is not limited thereto and also covers a configuration in which each of the above mentioned optical axis angle variable elements is arranged on the optical path of the optical system for recording. In the latter case, although the optical axis angle of the second light beam for servo operation is fixed, a position where the disc is radially irradiated with the first light beam may be shifted by changing the optical axis angle of the first light beam for recording. Owing to the above, the position of a recorded track may be scanned again with accuracy even when the current inclination angle of the optical disc is changed from the inclination angle obtained in former recording. Therefore, it is allowed to perform rewriting and erasing operations on a rewritable disc, and in additional recording, recorded information is not destroyed and any unrecorded area is not formed at the recording start position.

Details of the respective embodiments have been described for ready understanding of the present invention and the present invention is not always limited to those including all the above mentioned configurations. In addition, a part of a configuration of one embodiment may be replaced with a configuration of another embodiment, and a configuration of another embodiment may be added to a configuration of one embodiment. Further, another configuration may be added to, deleted from and replaced with a part of one configuration of each embodiment.

What is claimed is:

1. An optical pickup device which records and reproduces information on and from, or records or reproduces information on or from an optical disc in which a record layer on which information is recorded is separated from a guide layer which generates a servo signal, comprising:
a first laser diode which emits a first light beam used for information recording or reproduction on or from the record layer;
a second laser diode which emits a second light beam used for servo signal detection from the guide layer;
an objective lens which irradiates the record layer of the optical disc with the first light beam and the second light beam;
a first detector which receives the first light beam reflected from the optical disc;
a second detector which receives the second light beam reflected from the optical disc; and
an optical axis angle variable element which changes the direction of an optical axis of at least one of the first and second light beams which are incident from the objective lens upon the optical disc.

2. An optical pickup device which records and reproduces information on and from, or records or reproduces information on or from an optical disc in which a record layer on which information is recorded is separated from a guide layer which generates a servo signal, comprising:
a first laser diode which emits a first light beam used for information recording or reproduction on or from the record layer;
a second laser diode which emits a second light beam used for servo signal detection from the guide layer;
a first objective lens which irradiates the record layer of the optical disc with the first light beam;
a second objective lens which irradiates the guide layer of the optical disc with the second light beam;
a first detector which receives the first light beam reflected from the optical disc;
a second detector which receives the second light beam reflected from the optical disc; and
an optical axis angle variable element which changes the direction of an optical axis of at least one of the first and second light beams which are incident from the first and second objective lenses upon the optical disc.

3. The optical pickup device according to claim 1, wherein
the optical axis angle variable element changes the direction of the optical axis of only the second light beam which is incident upon the optical disc.

4. The optical pickup device according to claim 1, wherein
an angle variable mirror the angle of which is made variable is used as the optical axis angle variable element.

5. The optical pickup device according to claim 1, wherein
a movable lens which moves in a radius direction of the disc and a drive mechanism which drives the movable lens are used as the optical axis angle variable element.

6. The optical pickup device according to claim 1, wherein
a liquid crystal aberration element the refractive index of which is changed by voltage application and a voltage apply mechanism which applies a voltage to the liquid crystal aberration element are used as the optical axis angle variable element.

7. An optical disc apparatus on which the optical pickup device according to claim 1 is loaded so as to record and reproduce information on and from an optical disc in which a record layer on which information is recorded is separated from a guide layer on which a servo signal is recorded, comprising:
a laser lighting circuit which supplies driving currents to the first and second laser diodes;
an information signal recording circuit which supplies an information signal to be recorded on the record layer of the optical disc via the laser lighting circuit;
an information signal reproduction circuit which reproduces the information which is recorded on the record layer of the optical disc from a signal detected by the first detector;
a servo signal generation circuit which generates servo signals for use in focusing control and tracking control from signals recorded on the record layer and the guide layer of the optical disc which have been detected by the first and second detectors; and
an optical axis angle variable element drive circuit which adjusts the angle of the optical axis of the optical axis angle variable element, wherein
the optical axis angle variable element drive circuit adjusts the angle of the optical axis of the optical axis angle variable element such that a tracking error signal which is detected from the record layer by the first detector is reduced to almost zero in a state that tracking control is being performed on the basis of a signal which is detected from the record layer by the second detector.
